(19) United States
(12) Patent Application Publication
(10) Pub. No.: US 2024/0331723 A1
(43) Pub. Date: Oct. 3, 2024

(54) Record Cleaning Device and System

(71) Applicant: Red Vinyl Unlimited LLC, Livermore, CA (US)

(72) Inventors: Jeffrey Kaskey, Livermore, CA (US); Daniel Sayre, San Jose, CA (US)

(73) Assignee: Red Vinyl Unlimited LLC, Livermore, CA (US)

(21) Appl. No.: 18/614,641

(22) Filed: Mar. 23, 2024

Related U.S. Application Data
(60) Provisional application No. 63/455,564, filed on Mar. 30, 2023.

(51) Int. Cl. G11B 3/58; A47L 7/00; A47L 9/08

(52) U.S. Cl. CPC G11B 3/58; A47L 7/0009; A47L 9/08

(57) ABSTRACT

For phonograph record users, an apparatus for cleaning records is a common accessory. Such accessories range from handheld brushes to liquid-filled ultrasonic chambers and include rotating platforms for cleaning with fluids. The rotating platform facilitates manual or automatic cleaning of the record surface using a cleaning fluid applied with an applicator such as a brush or pad. The rotating platform systems typically provide a vacuum system for removing the fluid after said fluid has dissolved or suspended contaminants from the record surface. Many existing systems employ a vacuum through a slotted tube or wand to collect the cleaning fluid, but this can result in several deficiencies. For example, the record can be scratched from the wand, fluid absorbed from the wand's velvet may absorb some liquid which in turn gets rubbed back on the record, among other problems.

### CROSS-REFERENCES TO RELATED APPLICATIONS

This Non-Provisional patent application claims the benefit of and priority to U.S. Provisional Patent Application Ser. No. 63/455,564, filed Mar. 30, 2023, entitled “A Vacuum-Pressure Wand for Use with Record Cleaning Machines,” the entire contents of which are hereby incorporated herein by reference.

### BACKGROUND

For phonograph record users, an apparatus for cleaning records is a common accessory. Such accessories range from handheld brushes to liquid-filled ultrasonic chambers and include rotating platforms for cleaning with fluids. The rotating platform facilitates manual or automatic cleaning of the record surface using a cleaning fluid applied with an applicator such as a brush or pad. The rotating platform systems typically provide a vacuum system for removing the fluid after said fluid has dissolved or suspended contaminants from the record surface.

Many existing systems employ a vacuum through a slotted tube or wand to collect the cleaning fluid, which can result in several deficiencies. For example, the record can be scratched from the wand, and fluid absorbed from the wand's velvet may absorb some liquid, which in turn gets rubbed back on the record, among other problems.

### SUMMARY

A dual negative and positive air pressure wand is implemented by which the wand vacuums liquid and debris from the record while simultaneously outputting air pressure against the record's surface, which creates a buffer between the wand and the record's surfaces. The wand includes at least two connecting ports that independently connect to a positive air pressure source and a negative air pressure source. Each positive and negative connecting ports lead to independent and sealed channels within the wand that lead to positive pressure outputs and negative pressure outputs on a bottom side of the wand, which exerts the pressure against a record spinning on a record cleaning machine (RCM).

In typical implementations, the positive air pressure enters the positive pressure connecting port, advances through a dedicated channel near a central region of the wand, and outputs through multiple orifices spaced throughout the central region of the wand's bottom surface. The negative air pressure enters through the negative pressure connection port, advances through a dedicated channel around a perimeter of the wand's body, and ultimately through one or more elongated openings around the wand's perimeter. The elongated openings where the negative pressure is output are on an outer perimeter of the positive pressure orifices. Such a construction enables the negative pressure to vacuum the cleaning fluid and debris on the record while the positive air pressure at the orifices causes a steady space/distance between the wand and the record.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of a wand hovering above a record cleaning machine (RCM) to clean a record;

FIG. 2 shows an illustrative representation of the wand's positive and negative air pressure connecting ports on its top side;

FIG. 3 shows an illustrative cross-sectional representation including the wand's positive pressure channel;

FIG. 4 shows an illustrative cross-sectional representation of the wand's negative pressure channel;

FIGS. 5-6 show illustrative representations of the wand's bottom side, having positive and negative air pressure outputs; and

FIG. 7 shows an illustrative representation of the space between the wand and the record while the record-cleaning device is in use.

Like reference numerals indicate like elements in the drawings. Elements are not drawn to scale unless otherwise indicated.

### DETAILED DESCRIPTION

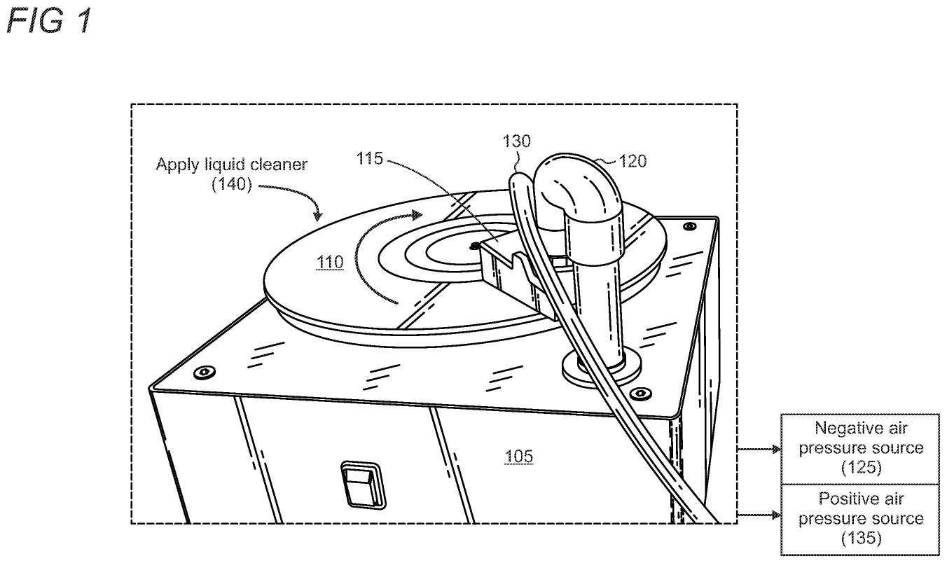

FIG. 1 shows an illustrative representation in which a RCM (record cleaning machine) 105 includes a positive and negative air pressure applications and a wand or puck 115 to clean a record 110. A negative air pressure source 125 is connected to the wand 115 via negative pressure tube 210. A positive air pressure source 135 is connected to the wand 115 via positive pressure tube 205. While certain tube sizes and dimensions are shown in FIG. 1, any size of tubes larger or smaller than that shown may be utilized to implement the system herein.

In typical implementations, a user may apply a liquid cleaner 140 to the record before operating and applying the wand 115 and air pressure sources. The liquid cleaner is then brushed on the record surface for cleaning, and the system discussed herein is used to remove the cleaning fluid containing the loosened dirt and dry the record. The RCM 105 is typically switched on so that the record 110 spins while the user brushes the record. Likewise, the record cleaning system herein leverages and operates while the RCM spins the record.

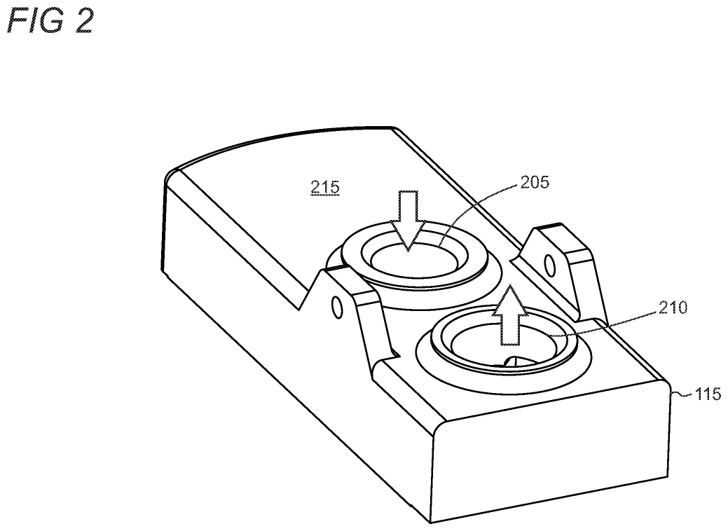

FIG. 2 shows an illustrative representation in which the wand 115 includes a positive pressure port 205 and a negative pressure port 210 on a top surface 215 thereof. While the ports are each shown on a top surface of the wand, in other implementations, one or both of the ports may be positioned on any surface thereof, including the left, right, front, rear, sides, or even a corner or edge. Multiple ports dedicated to a positive or negative air pressure source may also be implemented so long as the operations herein are achieved. As shown by the arrows in FIG. 2, the positive pressure port 205 pushes air toward and through the wand's interior body, while the negative pressure port 210 suctions air outward from the wand's interior body.

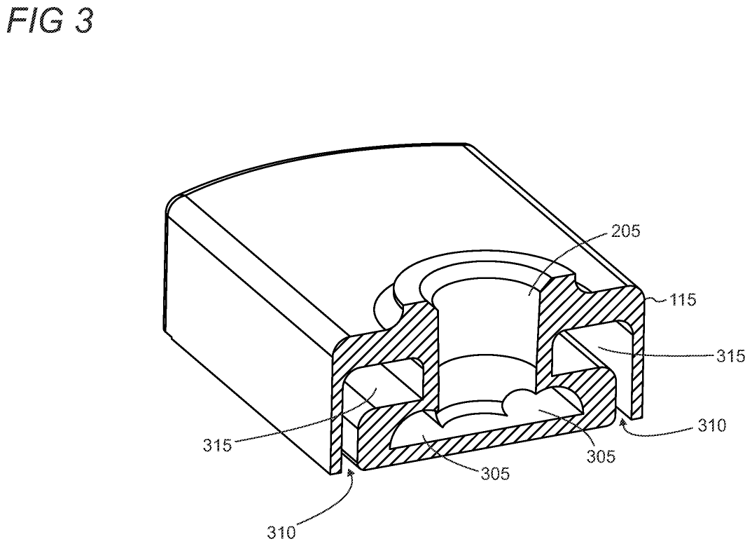

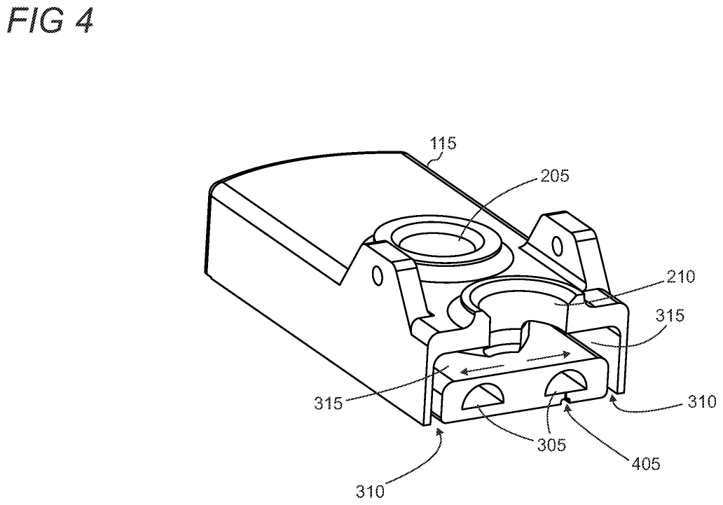

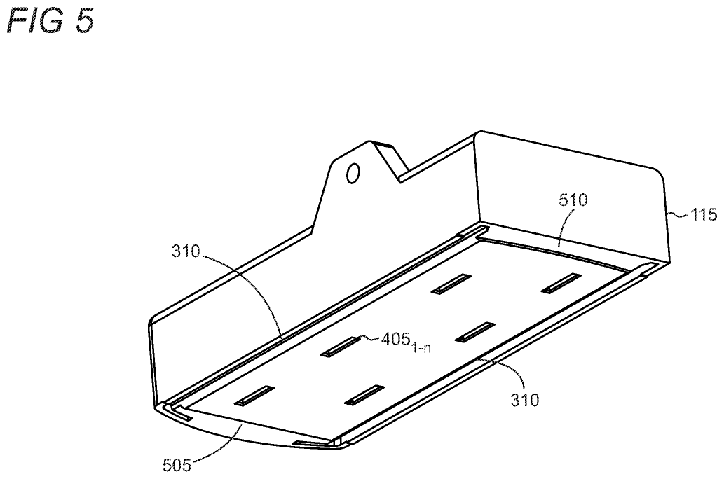

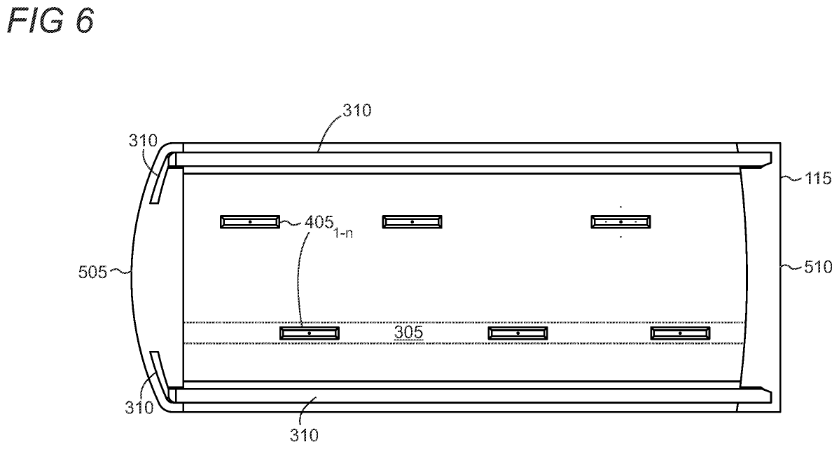

FIGS. 3 and 4 show illustrative cross-sectional representations in which the positive air pressure channels 305 and negative air pressure channels 315 allow the bi-directional air pressure to travel through the wand 115. Turning first to FIG. 3, the positive air port 205, hooked up to the positive pressure tube 130 (FIG. 1, not shown in FIG. 3 or 4), receives the positive air pressure from the positive air pressure source 135 and advances the air to the positive pressure channels 305. The positive pressure port 205 is sealed from the negative pressure channels 315, thereby preventing the positive air pressure from entering the negative pressure channels and negative pressure openings 310. FIG. 4 further shows the positive pressure orifice 405 through which the positive air pressure travels from the positive pressure channel 305, discussed in greater detail with respect to FIGS. 5 and 6. The positive pressure channels 305 may be independent of each other, but the positive pressure port 205 leads to both channels. In this regard, the positive pressure port may be evenly split between each positive pressure channel. However, in some implementations, the positive pressure port 205 may unevenly distribute air to the positive pressure channels 305.

Referring to FIG. 4, the negative pressure port 210, hooked up to the negative pressure tube 120 (FIG. 1, not shown in FIGS. 3 and 4), receives negative air pressure from the negative air pressure source 125 and suctions air through the wand 115 and toward the negative pressure tube 120. The negative pressure port leads to the negative pressure channels 315 and is independent of and sealed from the positive pressure port, channels, or positive pressure orifices 405. As shown in FIG. 4, the negative pressure channels are connected, thereby making air freely suction through the wand and toward the negative pressure source. However, in other implementations, the negative pressure channels may be sealed and independent from each other, like the positive air pressure channel 305 discussed above. The negative pressure channels 315 lead directly to the negative pressure openings 310 on opposing length sides of the wand. The negative pressure channel and opening can also lead to one or both of the front and rear-width sides. Some implementations may have a single negative pressure opening, such as on a single length side instead of both length sides.

FIGS. 5 and 6 show illustrative representations in which the positive pressure orifices 405 and negative pressure openings 310 respectively output positive air pressure and negative air pressure received at the positive and negative pressure ports 205, 210. Specifically, the positive air pressure travels from the positive pressure source 125 to the positive pressure port 205, the positive pressure channels 305, and ultimately out the positive pressure orifices 405. In some implementations, the positive pressure orifices 405 may be drilled after construction of the wand 115. The negative air pressure travels from the negative pressure source 135 to the negative pressure port 210, the negative pressure channels 315, and ultimately out the negative pressure openings 310. The dashed line in FIG. 6 figuratively represents the positive pressure channel that runs through the wand 115, but positive air pressure only escapes when a positive pressure orifice is present (the figurative channel would also be along the other set of orifices).

FIG. 5 further shows inner surface relief 505 and outer surface relief 510 positioned at the inner and outer sides of the wand relative to the record. To accommodate the record's topography, the inner and outer surface relief areas are slightly indented/recessed toward the wand. Specifically, records are typically thicker near the inner circle and the outer edges, which would thereby scrape against the wand 115 if it were completely flat. Thus, the inner and outer surface relief sections are slightly indented/recessed to accommodate the record's topography.

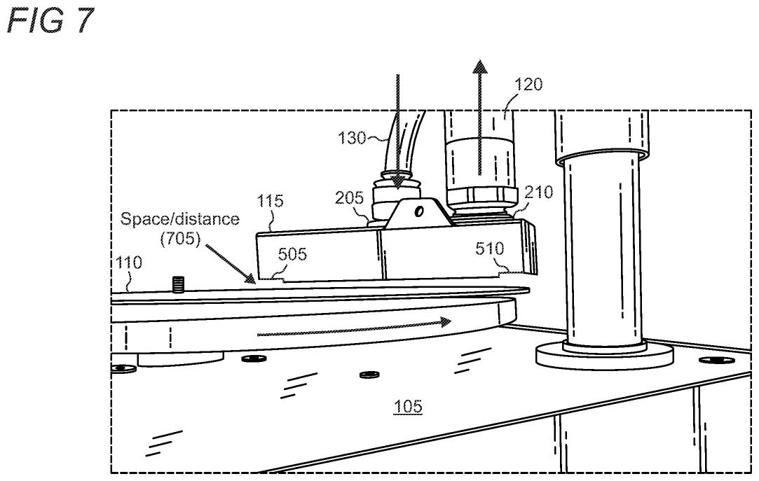

FIG. 7 shows an illustrative environment in which the wand 115 and record cleaning system are implemented against a record 110. While the RCM 105 is in an ‘on’ position and the record is spinning, the positive and negative air pressure sources 135, 125 are likewise switched on and actioned against the wand. The dual operation of the positive and negative air pressure at the wand causes the wand to output positive and negative air pressure simultaneously through the orifices 405 and openings 310. In this regard, while the negative air pressure performs a suctioning action against the record and thereby cleans debris from its surface, the positive air pressure pushes the wand away from the record and dries and cleans the record. This dual positive and negative air pressure action prevents the record from being suctioned against the wand's bottom surface while still performing this beneficial dual operation. FIG. 7 shows the space/distance 705 between the wand 115 and the record 110 while the record cleaning system and wand are in operation. Since the wand does not touch the record, any cleaning fluid is suctioned into it by the negative pressure and through the wand's negative pressure orifices and channels.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A wand for removing cleaning fluid from a record's surface, comprising:
a positive pressure connecting port;
a negative pressure connecting port;
a positive pressure channel through which positive pressure advances from the positive pressure connecting port;
a negative pressure channel through which negative pressure advances from the negative pressure connecting port;
at least one positive pressure orifice through which the positive pressure is output; and
at least one negative pressure opening through which the negative pressure is output,
wherein the at least one positive pressure orifice and the at least one negative pressure opening are on a same side of the wand.

2. The wand of claim 1, wherein the positive and negative pressure connecting ports are each positioned on a top side of the wand.

3. The wand of claim 1, wherein the at least one positive pressure orifice is positioned on a bottom side of the wand.

4. The wand of claim 1, wherein the at least one negative pressure opening is positioned on the bottom side of the wand.

5. The wand of claim 1, wherein the at least one negative pressure opening is an elongated opening along a perimeter portion of the wand, and wherein the at least one negative pressure opening is on an outer periphery of the at least one positive pressure orifices.

6. The wand of claim 1, wherein the positive and negative air pressure channels are completely separate and independent from each other.

7. The wand of claim 1, wherein the positive channel is positioned in a central region of the wand and leads to multiple positive pressure orifices of the at least one orifices.

8. The wand of claim 1, wherein the negative pressure channel is positioned on a perimeter portion of the wand, and wherein the negative pressure channel leads to two distinct negative pressure openings of the at least one negative pressure opening on opposing sides of the wand.
